(19) United States
(12) Patent Application Publication
(10) Pub. No.: US 2003/0154227 A1
(43) Pub. Date: Aug. 14, 2003

(54) Multi-threaded multiply accumulator

(75) Inventors: Jason M. Howard, Beaverton, OR (US); Yatin V. Hoskote, Portland, OR (US); Sriram R. Vangal, Hillsboro, OR (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/071,373

(22) Filed: Feb. 8, 2002

(51) Int. Cl. G06F 7/38

(52) U.S. Cl. 708/495

(57) ABSTRACT

A multiply-accumulate circuit includes a compressor tree to generate a product with a binary exponent and a mantissa in carry-save format. The product is converted into a number having a three bit exponent and a fifty-seven bit mantissa in carry-save format for accumulation. An adder circuit accumulates the converted products in carry-save format. The adder operates on floating point number representations having exponents with a least significant bit weight of thirty-two, and exponent comparisons within the adder exponent path are limited in size. The adder circuit includes intermediate registers to provide multi-threaded capability. Products interleaved in time are accumulated into separate sums simultaneously.

### FIELD

Embodiments of the present invention relates generally to floating point operations, and more specifically to floating point multiply accumulators.

### BACKGROUND

Fast floating point mathematical operations have become an important feature in modem electronics. Floating point units are useful in applications such as three-dimensional graphics computations and digital signal processing (DSP). Examples of three-dimensional graphics computation include geometry transformations and perspective transformations. These transformations are performed when the motion of objects is determined by calculating physical equations in response to interactive events instead of replaying prerecorded data.

Many DSP operations, such as finite impulse response (FIR) filters, compute Σ(aᵢ bᵢ), where i=0 to n−1, and aᵢ and bᵢ are both single precision floating point numbers. This type of computation typically employs floating point multiply accumulate (FMAC) units which perform many multiplication operations and add the resulting products to give the final result. In these types of applications, fast FMAC units typically execute multiplies and additions in parallel without pipeline bubbles. One example FMAC unit is described in: Nobuhiro et al., “2.44-GFLOPS 300-MHz Floating-Point Vector Processing Unit for High-Performance 3-D Graphics Computing,” IEEE Journal of Solid State Circuits, Vol. 35, No. 7, July 2000.

For the reasons stated above, and for other reasons stated below which will become apparent to those skilled in the art upon reading and understanding the present specification, there is a need in the art for fast floating point multiply and accumulate circuits.

### BRIEF DESCRIPTION OF THE DRAWINGS

FIG. 1 shows a multi-threaded accumulator circuit;

FIG. 2 shows an integrated circuit with a multi-threaded multiply accumulate circuit;

FIG. 3 shows a multi-threaded floating point multiply-accumulate circuit;

FIG. 4 shows a mantissa multiplier circuit;

FIG. 5 shows a floating point conversion unit;

FIG. 6 shows a carry-save negation circuit;

FIG. 7 shows a base 32 floating point number representation;

FIG. 8 shows an exponent path of a floating point adder;

FIG. 9 shows a mantissa path of a floating point adder;

FIG. 10 shows a post-normalization circuit; and

FIG. 11 shows a sign detection circuit.

### DESCRIPTION OF EMBODIMENTS

In the following detailed description of the embodiments, reference is made to the accompanying drawings which show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claim are entitled.

### Multi-Threaded Accumulator

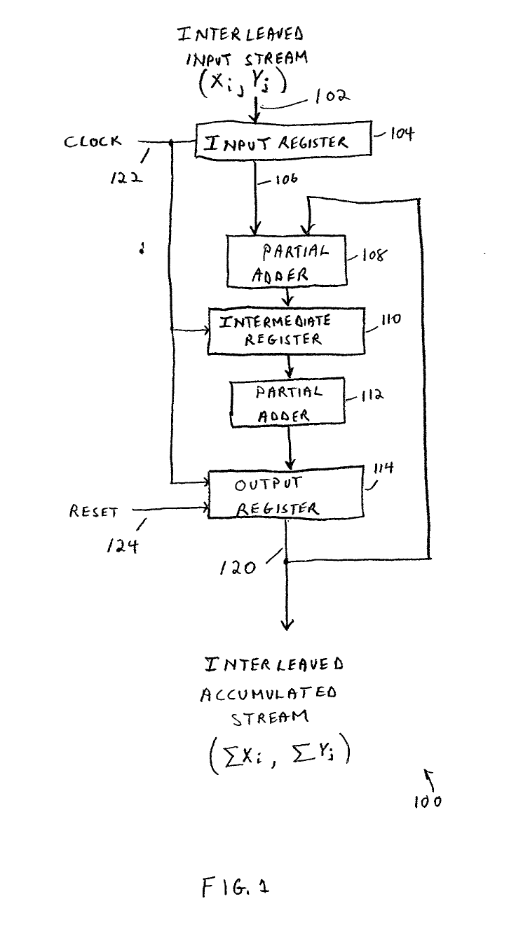

FIG. 1 shows a multi-threaded accumulator circuit. Circuit 100 includes input register 104, intermediate register 110, output register 114, and partial adders 108 and 112. Registers 104, 110, and 114 each receive a clock signal on node 122, and register 114 receives a reset signal on node 124. Registers 104, 110, and 114 store information that is updated on each clock cycle, and register 114 presents a “zero” output when the reset signal on node 124 is asserted.

Circuit 100 receives an interleaved input stream on node 102 and produces an interleaved accumulated stream on output node 120. As shown in FIG. 1, the interleaved input stream on node 102 includes two data streams, Xᵢ and Yⱼ, where i and j are subscripts that indicate the input streams X and Y can be any length. The data in the two input streams alternate in time, or are “interleaved.” For example, a sample data stream on node 102 might include the sequence {X₃, Y₇, X₄, Y₈, X₅, Y₉}. The output data on node 120 is also interleaved. For example, as shown in FIG. 1, the output data on node 120 alternates between ΣXᵢ and ΣYⱼ.

In some embodiments, circuit 100 receives input streams X and Y as integer operands. In other embodiments, circuit 100 receives input streams X and Y as floating point operands. In general, circuit 100 can be made to operate on input streams represented in any known number format.

In operation, partial adder 108 receives two operands. A first operand is provided by input register 104 on node 106, and a second operand is fedback on output node 120. Partial adder 108 partially sums the two operands, and the results are stored in intermediate register 110. On the next clock cycle, the contents of intermediate register 110 are input to partial adder 112 which completes the addition operation, and the results are stored output register 114. Intermediate register 110 is a sequential element. Any type of sequential element can be utilized for intermediate register 110. For example, in some embodiments, intermediate register 110 includes edge-sensitive flip-flops, and in other embodiments, intermediate register 110 includes level-sensitive transparent latches.

Each node in FIG. 1 is shown as a single line for clarity. Most of these nodes include many physical connections, or “traces.” For example, operands generally include multiple bits to represent a number. Therefore, nodes that represent numbers, such as nodes 102, 106, and 120, include many physical connections. This convention is used throughout this description, and nodes shown as single lines are not necessarily intended to represent a single physical connection.

At any time during the operation of circuit 100, sums and partial sums from the two interleaved data streams are stored in various registers. For example, during every other clock cycle, output register 114 includes ΣXᵢ, and during the other clock cycles, output register 114 includes ΣYⱼ. Also for example, during every other clock cycle, intermediate register 110 includes a partial sum of ΣXᵢ and during the other clock cycles, intermediate register 110 includes a partial sum of ΣYⱼ. Table 1, below, shows the contents of input register 104, intermediate register 110, and output register 114, during the accumulation of two data streams, ΣXᵢ and ΣYⱼ, where i and j take values from one to three. Each row in Table 1 represents one clock period.

TABLE 1

| Input | Input | Intermediate | Output |
|---|---|---|---|
| Stream | Register | Register | Register |
| X₁ | Don't Care | Don't Care | 0 (Reset Asserted) |
| Y₁ | X₁ | Don't Care | 0 (Reset Asserted) |
| X₂ | Y₁ | X₁ | 0 (Reset Asserted) |
| Y₂ | X₂ | Y₁ | X₁ |
| X₃ | Y₂ | X₁ + X₂ (Partial Sum) | Y₁ |
| Y₃ | X₃ | Y₁ + Y₂ (Partial Sum) | X₁ + X₂ |
| Don't | Y₃ | X₁ + X₂ + X₃ (Partial Sum) | Y₁ + Y₂ |
| Care | | | |
| Don't | Don't Care | Y₁ + Y₂ + Y₃ (Partial Sum) | X₁ + X₂ + X₃ |
| Care | | | |
| Don't | Don't Care | Don't Care | Y₁ + Y₂ + Y₃ |
| Care | | | |

Accumulator circuit 100 is a “multi-threaded” accumulator because it operates on two “threads” simultaneously. One thread is represented by Xᵢ, and the other thread is represented by Yⱼ. Embodiments represented by FIG. 1 operate on two threads at once. In other embodiments, three or more threads are operated on at once. The number of threads that can be operated on simultaneously is a function of the number of partial adders and intermediate registers included in the circuit. For example, in embodiments with three partial adders and two intermediate registers, three threads can be accumulated simultaneously.

Multi-threaded accumulator 100 operates at a high clock speed in part because each partial adder is faster than a full adder. By storing partial summation results in intermediate register 110, the summation operation is separated in two stages, where each stage is faster than a full adder. One stage is implemented by partial adder 108, and the other stage is implemented by partial adder 112.

### Multi-Threaded Multiply-Accumulator

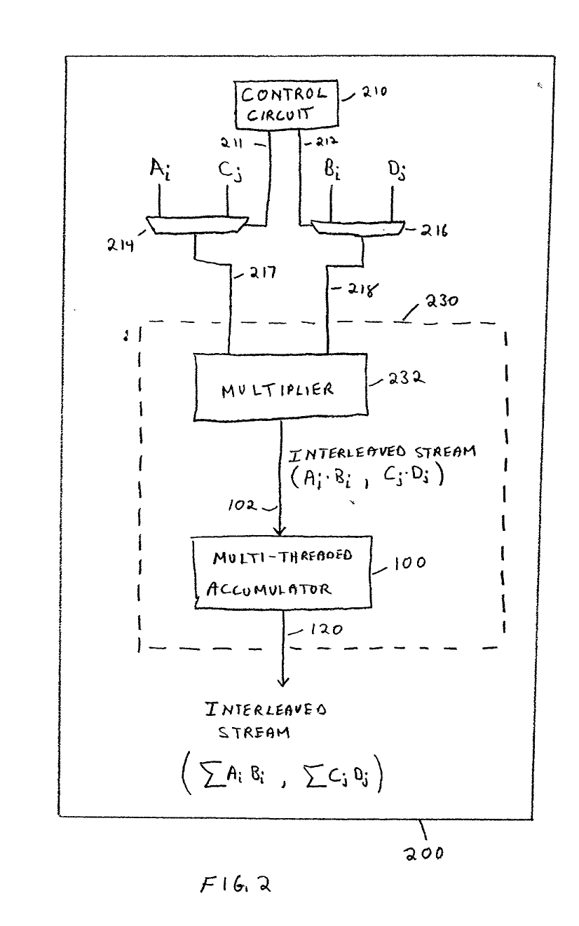

FIG. 2 shows an integrated circuit with a multi-threaded multiply-accumulate circuit. Integrated circuit 200 includes control circuit 210, multiplexors 214 and 216, and multi-threaded multiply-accumulator 230. Multiplexor 214 receives inputs Aᵢ and Cⱼ, and provides an output on node 217. Multiplexor 216 receives inputs Bᵢ and Dⱼ, and provides an output on node 218. Nodes 217 and 218 provide operands to multiply-accumulator 230.

In operation, control circuit 210 provides control signals to multiplexors 214 and 216 on nodes 211 and 212, respectively. As a result, the operands on nodes 217 and 218 are interleaved between the sets {Aᵢ, Bᵢ} and {Cⱼ, Dⱼ}. Multiplier 232 receives the interleaved operands on nodes 217 and 218, multiplies them, and produces a data stream on node 102 interleaved between the products (AᵢBᵢ) and (CⱼDⱼ);

Multi-threaded accumulator circuit 100 receives the interleaved products on node 102, and produces an interleaved output stream on node 120 that alternates between ΣAᵢBᵢ and ΣCⱼDⱼ.

Control circuit 210 and multiplexors 214 and 216 provide a mechanism to interleave input operands for multiply-accumulator 230. In some embodiments, control circuit 210 is a state machine, and in other embodiments, control circuit 210 is a processor. In general, control circuit 210 can be any circuit capable of performing the interleaving. In some embodiments, control circuit 210 and multiplexors 214 and 216 are omitted, and interleaved data streams are provided directly on nodes 217 and 218. For example, in some embodiments, integrated circuit 200 is a graphics processing integrated circuit that operates on multiple interleaved data streams directly.

In some embodiments, multiply-accumulator 230 performs integer multiplications and additions. For example, in some embodiments, input operands on nodes 217 and 218 are signed numbers in twos-complement format. In other embodiments, multiply-accumulator 230 performs floating point multiplications and additions. For example, in some embodiments, input operands on nodes 217 and 218 are floating point numbers that include sign bits, exponent fields, and mantissa fields. The remainder of this description focuses on embodiments that operate on floating point numbers.

Integrated circuit 200 can be any type of integrated circuit capable of including a multiply accumulate circuit. For example, integrated circuit 200 can be a processor such as a microprocessor, a digital signal processor, a micro controller, or the like. Integrated circuit 200 can also be an integrated circuit other than a processor such as an application-specific integrated circuit (ASIC), a communications device or a memory controller.

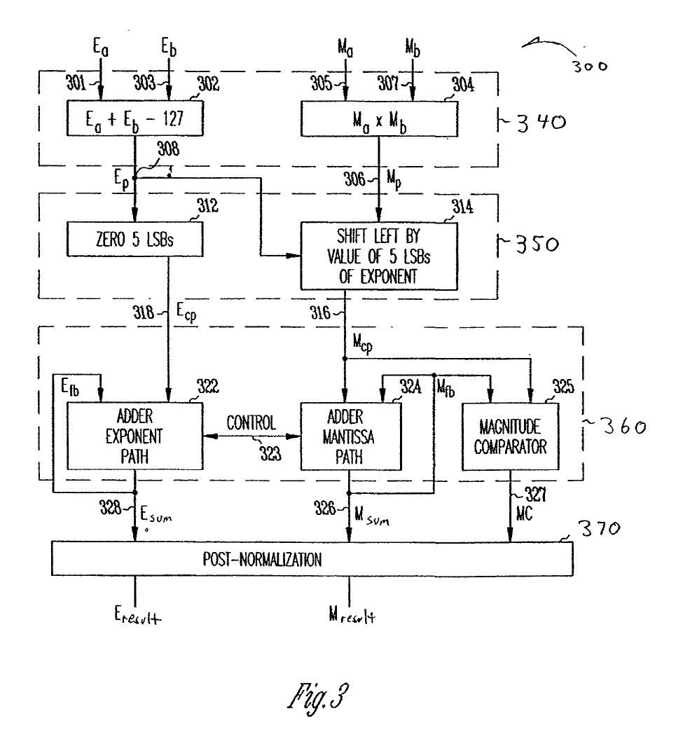

FIG. 3 shows a multi-threaded floating point multiply-accumulate circuit. Multiply-accumulate circuit 300 includes floating point multiplier 340, floating point conversion unit 350, floating point adder 360, and post-normalization circuit 370. Each of the elements shown in FIG. 3 is explained in further detail with reference to figures that follow. In this section, a brief overview of the FIG. 3 elements and their operation is given to provide a context for more detailed explanations that follow.

In general, floating-point numbers are represented as a concatenation of a sign bit, an exponent field, and a significand field (also referred to as the mantissa). The Institute of Electrical and Electronic Engineers (IEEE) has published an industry standard for floating point operations in the ANSI/IEEE Std 754-1985, IEEE Standard for Binary Floating-Point Arithmetic, IEEE, New York, 1985, hereinafter referred to as the “IEEE standard.” In the IEEE single precision floating-point format, the most significant bit (integer bit) of the mantissa is not represented. The most significant bit of the mantissa has an assumed value of 1, except for denormal numbers, whose most significant bit of the mantissa is 0. A single precision floating point number as specified by the IEEE standard has a 23 bit mantissa field, an eight bit exponent field, and a one bit sign field. The remainder of this description is arranged to describe multiply-accumulate operations on IEEE single precision floating point numbers, but this is not a limitation. IEEE compliant numbers have been chosen for illustration of various embodiments of the present invention because of their wide-spread use, but one skilled in the art will understand that any other floating point or integer format can be utilized.

Operations involving the sign bits of the floating point numbers are not shown in FIG. 3. Instead, all operations involving sign bits are presented in detail in later figures. For all floating point numbers referred to in this description, all sign bits, exponent fields, and mantissa fields are labeled with a capital S, E, and M, respectively, with an identifying subscript. For example, floating point number A includes sign bit Sₐ, exponent field Eₐ, and mantissa field Ma, and floating point number B includes sign bit S_{b}, exponent field E_{b}, and mantissa field M_{b}.

Floating point multiplier 340 receives two floating point operands, operand A on nodes 301 and 305, and operand B on nodes 303 and 307, and produces a floating point product on nodes 308 and 306. The floating point product is converted to a different floating point representation by floating point conversion unit 350. Nodes 318 and 316 hold the converted product generated by floating point conversion unit 350.

Floating point adder 360 receives the converted product, and also receives a previous sum on nodes 328 and 326. Floating point adder 360 then produces a present sum on nodes 328 and 326. It should be noted that the output of floating point adder 360 is not normalized prior to being fed back for accumulation. The lack of a normalization circuit in the feedback path provides for a faster floating point mutliply-accumulate circuit. Post-normalization circuit 370 receives the sum on nodes 328 and 326, and produces a result (Eᵣₑₛᵤₗₜ, Mᵣₑₛᵤₗₜ). Again, it should be noted that the post-normalization operation is reserved for the end of the multiply-accumulate circuit rather than immediately after both the multiplier and the adder.

Floating point multiplier 340 includes exponent path 302 and mantissa path 304. Floating point multiplier 340 also includes an exclusive-or gate (not shown) to generate the sign of the product, Sₚ, from the signs of the operands, Sₐ and S_{b}, as is well known in the art. Exponent path 302 includes an exponent summer that receives exponents Eₐ and E_{b} on nodes 301 and 303 respectively, and sums them with negative 127 to produce the exponent of the product, Eₚ, on node 308. Eₐ and E_{b} are each eight bit numbers, as is Eₚ. Negative 127 is summed with the exponent fields because the IEEE single precision floating point format utilizes biased exponents. Exponent path 302 can be implemented using standard adder architectures as are well known in the art.

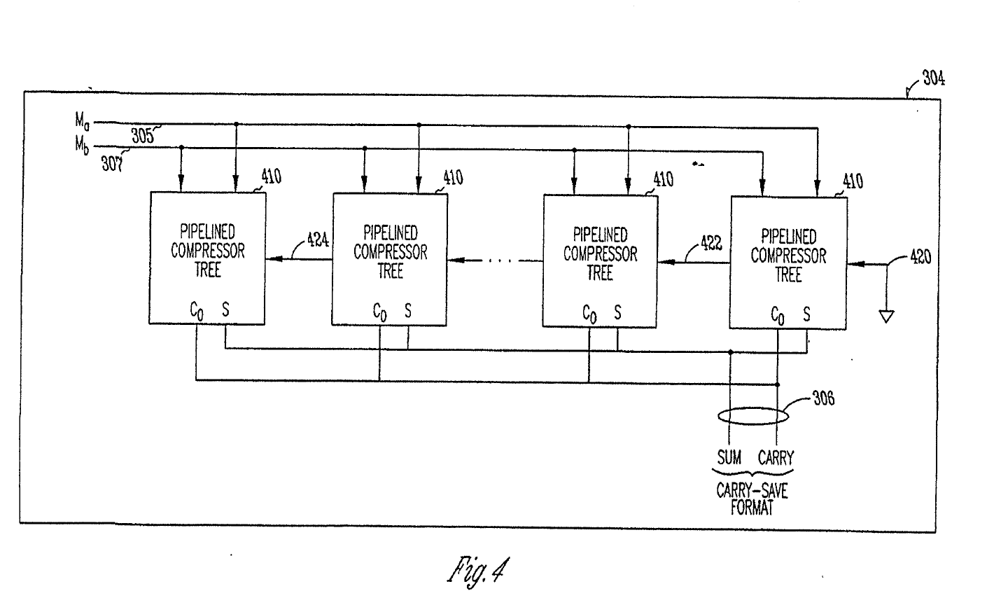

Mantissa path 304 receives mantissas Ma and Mb on nodes 305 and 307, respectively. Mantissa path 304 includes a mantissa multiplier that multiplies mantissas Mₐ and M_{b}, and produces the mantissa of the product, Mₚ, on node 306. Mantissas Mₐ and M_{b} are each 23 bits in accordance with the IEEE standard, and mantissa Mₚ is 24 bits in carry-save format. Mantissa path 304 and carry-save format, are described in more detail with reference to FIG. 4 below.

The exponent of the product, Eₚ, is an eight bit number with a least significant bit weight equal to one. For example, an Eₚ field of 00000011 has a value of three, because the least significant bit has a weight of one, and the next more significant bit has a weight of two. For the purposes of this description, this exponent format is termed “base 2,” and the product is said to be in base 2. Floating point conversion unit 350 converts the product from base 2 to a different base. For example, exponent path 312 is an exponent conversion unit that sets the least significant five bits of the exponent field to zero, and truncates the exponent field to three bits, leaving the least significant bit of the exponent of the converted product, E_{cp}, with a weight of 32. For example, an E_{cp} field of 011 has a value of 96, because the least significant bit has a weight of 32, and the next more significant bit has a weight of 64. For the purposes of this description, this exponent format is termed “base 32,” and the converted product is said to be in base 32.

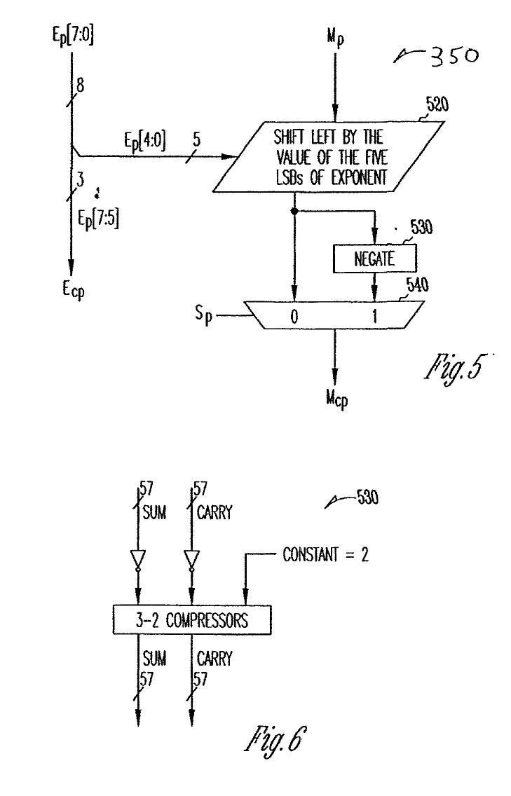

Mantissa path 314 of floating point conversion unit 350 shifts the mantissa of the product, Mₚ, to the left by the number of bit positions equal to the value of the least significant five bits of the exponent of the product, EP. Mantissa path 314 presents a 57 bit mantissa in carry-save format on node 316. Floating point conversion unit 350 does not operate on the sign bit, so the sign of the converted product, S_{cp}, is the same as the sign of the product, Sₚ. One embodiment of floating point conversion unit 350 is shown in more detail in FIG. 5.

Floating point adder 360 includes adder exponent path 322, adder mantissa path 324, and magnitude comparator 325. Exponent path 322 includes an exponent accumulation stage that receives the converted product exponent, E_{cp} on node 318, and the feedback exponent, E_{fb}, on node 328, and produces the sum exponent Eₛᵤₘ on node 328. The sum is a base 32 number in carry-save format. Exponent path 322 also produces control signals on node 323. Node 323 carries information from exponent path 322 to mantissa path 324 to signify whether the two exponents are equal (E_{cp}=E_{fb}), whether one exponent is greater than the other (E_{cp}>E_{fb}, E_{cp}, <E_{fb}), and whether one exponent is one greater than the other or two greater than the other (E_{cp}=E_{fb}+1, E_{fb}=E_{cp}+1, E_{fb}=E_{cp}+2). Because the converted product and the sum are floating point numbers in base 32 format, an exponent that differs by a least significant bit differs by a “weight” of thirty-two. Exponent path 322 also receives overflow signals and other control signals from mantissa path 324 on node 323.

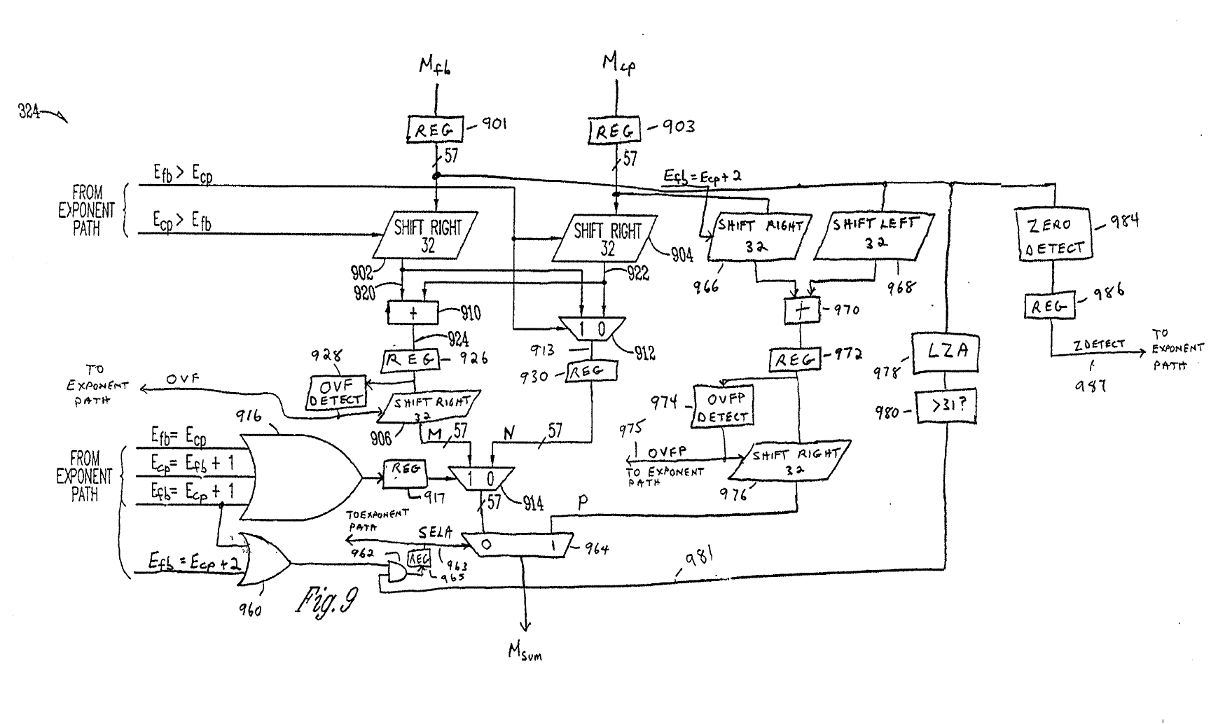

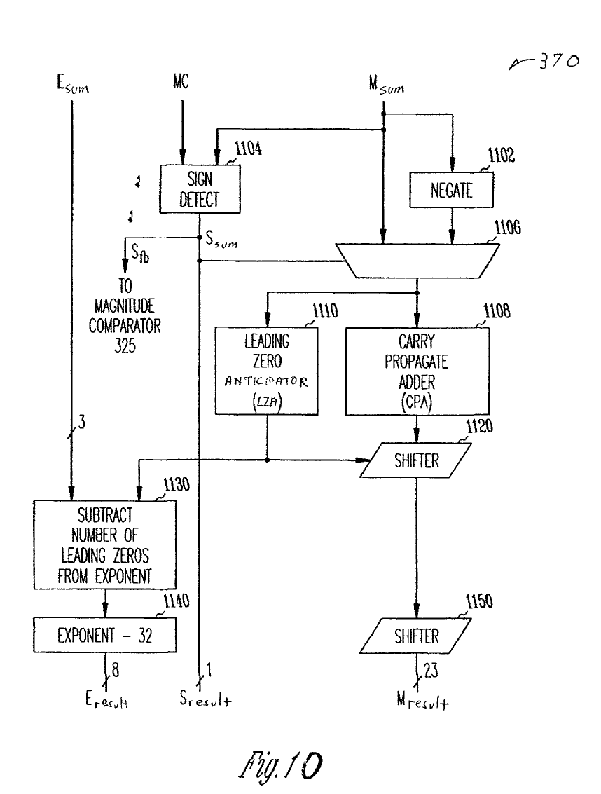

Mantissa path 324 includes a mantissa accumulator that receives mantissa fields M_{cp} and M_{fb} on nodes 316 and 326, respectively, and produces mantissa field Mₛᵤₘ on node 326. Mantissa path 324 also receives control signals on node 323 from exponent path 322, and produces overflow signals and other signals and sends them to exponent path 322. Embodiments of adder exponent path 322 and adder mantissa path 324 and the signals therebetween are described in more detail with reference to FIGS. 8 and 9, below. Magnitude comparator 325 receives mantissa fields M_{cp} and M_{fb} on nodes 316 and 326, respectively, and produces a magnitude compare (MC) result on node 327. MC is used by post-normalization circuit 370 to aid in the determination of the sign of the result, as is further explained below with reference to FIGS. 11 and 12.

Post-normalization circuit 370 receives the base 32 carry-save format sum from floating point adder 360, and converts it to an IEEE single precision floating point number. One embodiment of post-normalization circuit 370 is described in more detail with reference to FIG. 11, below.

### Multiplier

As previously described, multiplier 340 includes an exclusive-or function for sign bit generation, an exponent path for generating the exponent of the product, and a mantissa path to generate a mantissa of the product in carry-save format. FIG. 4 shows an embodiment of multiplier mantissa path 304. Mantissa path 304 includes a plurality of compressor trees 410. Each of compressor trees 410 receives a part of mantissa Mₐ on node 305 and a part of a mantissa M_{b} on node 307, and produces carry and sum signals to form mantissa Mₚ on node 306 in carry-save format. Carry-save format is a redundant format wherein each bit within the number is represented by two physical bits, a sum bit and a carry bit. Therefore, a 24 bit number in carry-save format is represented by 48 physical bits: 24 bits of sum, and 24 bits of carry. Each of compressor trees 410 generates a single sum bit and a single carry bit. Embodiments that produce a 24 bit carry-save number include 24 compressor trees 410.

Prior art multipliers that utilize compressor trees typically include a carry propagate adder (CPA) after the compressors to convert the carry-save format product into a binary product. See, for example, G. Goto, T. Sato, M. Nakajima, & T. Sukemura, “A 54×54 Regularly Structured Tree Multiplier,” IEEE Journal of Solid State Circuits, p. 1229, Vol. 27, No. 9, September 1992. Various embodiments of the method and apparatus of the present invention do not include a CPA after the compressors, but instead utilize the product directly in carry-save format.

Each compressor tree 410 receives carry signals from a previous stage, and produces carry signals for the next stage. For example, the least significant compressor tree receives zeros on node 420 as carry in signals, and produces carry signals on node 422 for the next significant stage. The most significant compressor tree receives carry signals from the previous stage on node 424.

Each compressor tree 410 includes a plurality of 3-2 compressors and/or 4-2 compressors arranged to sum partial products generated by partial product generators. For a discussion of compressors, see Neil H. E. Weste & Kamran Eshragihan, “Principles of CMOS VLSI Design: A Systems Perspective,” 2^{nd} Ed., pp. 554-558 (Addison Wesley Publishing 1994).

### Floating Point Conversion Unit

FIG. 5 shows a floating point conversion unit. Floating point conversion unit 350 receives the eight bit exponent field of the product, Eₚ[7:0], where Eₚ[7] is the most significant bit, and Eₚ[0] is the least significant bit. The exponent of the converted product, E_{cp}, is created by removing the least significant five bits from the exponent field. E_{cp} has a least significant bit equal to Eₚ[5], which has a weight of thirty-two.

Shifter 520 receives the 24 bit product mantissa, Mₚ, in carry-save format, and shifts both the sum field and the carry field left by an amount equal to the value of the least significant five bits of the product exponent, Eₚ[4:0]. If the product is negative, multiplexer 540 selects a negated mantissa that is negated by negation circuit 530. M is a 57 bit number in carry-save format, and E is a three bit exponent.

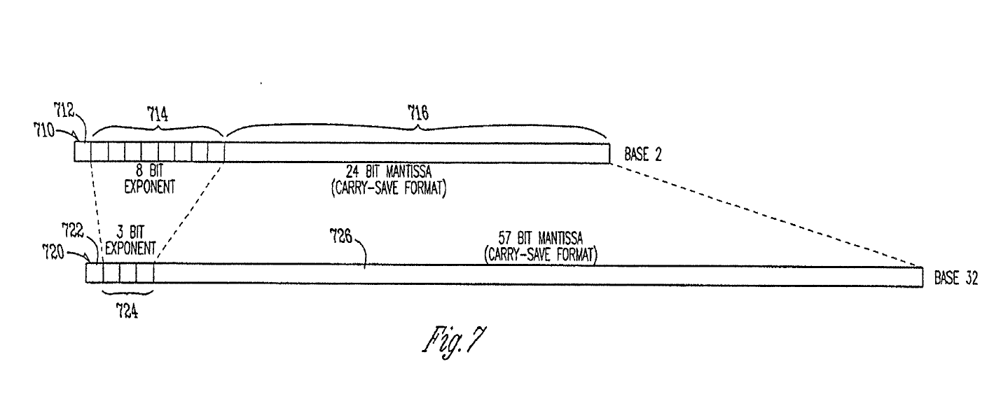

FIG. 6 shows a carry-save negation circuit. Carry-save negation circuit 530 negates a number in carry-save format. Both the sum and carry signals are inverted, and combined with a constant of two using a three-to-two compressor. Carry-save negation circuit 530 negates a 57 bit carry-save number. An example using a six bit carry-save number is now presented to demonstrate the operation of three-to-two compressors to negate a carry-save number. A six bit carry-save number with a value of six is represented as follows:

| | |
|---|---|
| 000010 | <-sum |
| 000100 | <-carry |

When both the sum and carry bits above are summed, the result is 000110, which equals six. The carry-save negation circuit inverts the sum and carry signals and adds two as follows:

| | |
|---|---|
| 111101 | <-inverted sum |
| 111011 | <-inverted carry |
| 000010 | <-constant of two |
| 000100 | <-resulting sum |
| 111011 | <-resulting carry |

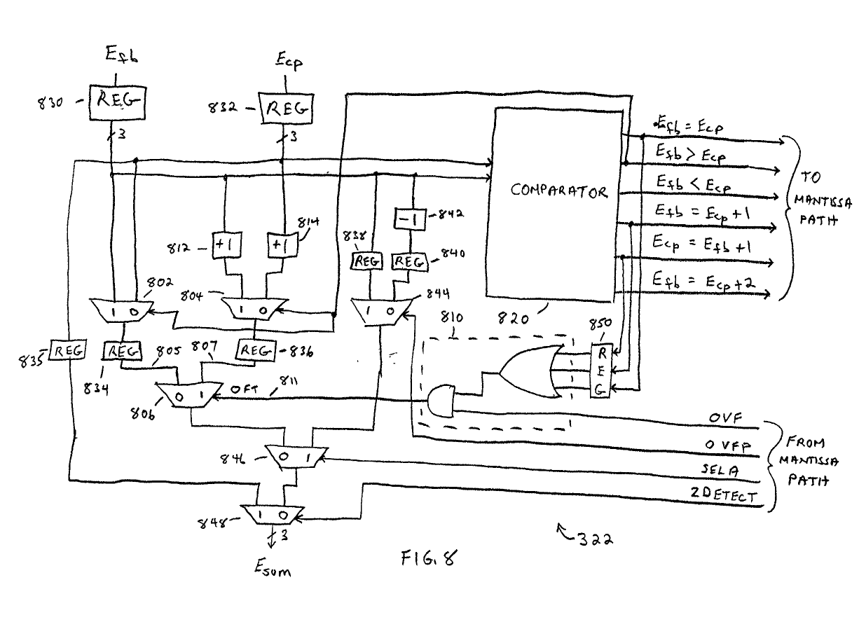

FIG. 7 shows base 2 and base 32 floating point number representations. Base 2 floating point number representation 710 is the representation produced by floating point multiplier 340 (FIG. 3), and base 32 floating point number representation 720 is the representation produced by floating point conversion unit 350 (FIG. 3). Base 2 floating point number representation 710 includes sign bit 712, eight bit exponent field 714, and twenty-four bit mantissa field 716. Base 2 floating point number representation 710 is in the IEEE standard single precision format with an explicit integer bit added to increase the mantissa from twenty-three bits to twenty-four bits. Base 32 floating point number 720 includes a sign bit 722, a three bit exponent field 724, and a fifty-seven bit mantissa field 726. Floating point conversion unit 350 (FIG. 6) converts floating point numbers in representation 710 to floating point numbers in representation 720.

Exponent 724 is equal to the most significant three bits of exponent 714. The least significant bit of exponent 724 has a “weight” of thirty-two. In other words, a least significant change in exponent 724 corresponds to a mantissa shift of thirty-two bits. For this reason, floating point representation 720 is referred to as a “base 32” floating point representation.

### Floating Point Adder

FIG. 8 shows an exponent path of a floating point adder. Exponent path 322 includes multiplexors 802, 804, 806, 844, 846, and 848, comparator 820, incrementers 812 and 814, decrementer 842, registers 830, 832, 834, 835, 836, 838, 840, and 850, and logic 810. Registers 830 and 832 capture the values of E_{fb} and E_{cp} respectively. Because the values of E_{fb} and E_{cp} are not changed by the action of registers 830 and 832, the terms “E_{fb}” and “Eₚ” are used to describe the input to registers 830 and 832, as well as their contents. Incrementers 812 and 814 pre-increment E_{fb} and Eₚ to produce an incremented E_{fb} and an incremented E_{cp}, respectively. When either exponent E_{fb} or E_{cp} is incremented, the value of the exponent is changed by thirty-two with respect to the mantissa. Accordingly, incrementers 812 and 814 are shown in FIG. 5 with the label “+1.” Likewise, decrementer 842 pre-decrements E_{fb} and the resulting value is changed by thirty-two with respect to the mantissa.

In operation, comparator 820 compares exponents E_{fb} and E_{cp}, and generates logic outputs as shown in FIG. 8. When E_{fb} is greater than E_{cp}, the (E_{fb}>E_{cp}) signal controls multiplexors 802 and 804 to select E_{fb} and the incremented E_{fb}, respectively. Otherwise, multiplexors 802 and 804 select E_{cp} and the incremented E_{cp}, respectively. Multiplexor 806 selects either the exponent on node 805 or the incremented exponent on node 807 based on the overflow trigger (OFT) signal on node 811. OFT is asserted only if the OVF signal is asserted and the two three-bit input exponents are either equal or differ by one. Logic 810 receives OVF from the mantissa path and logic outputs from comparator 820, and produces the OFT signal according to the following equation:

OFT=OVF AND ((E_{fb}=E_{cp}) OR (E_{fb}=E_{cp}+1) OR (E_{cp}=E_{fb}+1)).

When OFT is true, the output of multiplexor 806 is chosen as the incremented exponent on node 807, and when OFT is false, the output of multiplexor 806 is chosen as the greater exponent on node 805.

Multiplexor 844 selects either E_{fb} or the decremented E_{fb} based on the overflow signal (OVFP) received from the mantissa path. Multiplexor 846 selects between the outputs of multiplexors 806 and 844 based on the select signal (SELA) received from the mantissa path, and multiplexor 848 selects between E_{cp} and the output of multiplexor 846 based on the zero detect (ZDETECT) signal received from the mantissa path. The output of multiplexor 848 is the three bit exponent of the sum, Eₛᵤₘ.

Comparator 820 compares three bit exponents and produces a plurality of outputs that are logic functions of the inputs. Each logic output is a function of six input bits: three bits from E_{fb}, and three bits from E_{cp}. This provides a very quick logic path. In addition to the quick comparison made in the exponent path, the mantissa path includes constant shifters that conditionally shift mantissas by a fixed amount. The combination of a quick exponent comparison in the exponent path and a quick shift in the mantissa path provide for a fast floating point adder circuit. The constant shifter is described in more detail below with reference to FIG. 9.

Exponent path 322 is pipelined using registers 834, 835, 836, 838, 840, and 850. As a result of the pipelining, the work of the exponent path is performed in two stages, and partial results are stored in intermediate registers. This is similar to the two stages discussed with respect to FIG. 1.

FIG. 9 shows a mantissa path of a floating point adder. Mantissa path 324 includes constant shifters 902, 904, 906, 966, 968, and 976, adder circuits 910 and 970, and multiplexors 912, 914, and 964. Mantissa path 324 also includes registers 901, 903, 926, 930, 972, 986, 917, and 963, overflow detectors 928 and 974, logic 916, 960, and 962, leading zero anticipator (LZA) 978, comparator 980, and zero detector 984. Constant shifters 902, 904, 906, 966, 968, and 976 can be used in place of variable shifters because a change in the least significant bit of the exponent is equal to a shift of thirty-two. This simplification saves on the amount of hardware necessary to implement the adder, and also decreases execution time. In some embodiments, constant shifters 902, 904, 906, 966, 968, and 976 are implemented as a series of two-input multiplexors.

Mantissa path 324 receives mantissa M_{fb} and mantissa M_{cp} at registers 901 and 903, respectively. Because the values of M_{fb} and M_{cp} are not changed by the action of registers 901 and 903, the terms “M_{fb}” and “M_{cp}” are used to describe the input to registers 901 and 903, as well as their contents. Zero detector 984 detects whether M_{fb} is all zeros, and the result is captured in register 986. The output of register 986 is the ZDETECT signal on node 987, which is provided to exponent path 322.

The mantissa of the sum, Mₛᵤₘ, can be generated in one of three data paths: path M, path N, or path P. The various paths are labeled on the figure at the inputs to multiplexors 914 and 964. Path M is referred to as the “adder path” because the mantissas are summed in adder 910. Path N is referred to as the “bypass path” because the summation of adder 910 is bypassed. Path P is referred to as the “partial normalization path” because a partial normalization is performed.

In the operation of the adder and bypass paths, constant shifter 904 shifts M_{cp} thirty-two bit positions to the right when E_{fb} is greater than E_{cp}, and constant shifter 902 shifts M_{fb} thirty-two bit positions to the right when E_{cp} is greater than E_{fb}. When E_{fb} is equal to E_{cp}, then neither mantissa is shifted in either the adder path or bypass path.

In the adder path, adder circuit 910 compresses the two mantissas in carry-save format on nodes 920 and 922 and produces the result in carry-save format on node 924. In some embodiments, adder circuit 910 includes four-to-two compressors to compress the two input mantissas into the result on node 924. Node 924 is coupled to the input of register 926, which is an intermediate register similar to intermediate register 110 (FIG. 1). Shifters 902 and 904 and adder circuit 910 are in the adder path prior to the intermediate register, and shifter 906 and multiplexors 914 and 964 are in the adder path subsequent to the intermediate register. Overflow detector 928 detects if an overflow occurs in adder circuit 910. If an overflow is detected, the OVF signal is asserted and constant shifter 906 shifts the mantissa produced by adder circuit 910 thirty-two bit positions to the right. The OVF signal is sent to exponent path 322 to conditionally select an incremented exponent, as described above with reference to FIG. 8.

In the bypass path, multiplexor 912, like adder circuit 910, receives mantissas on nodes 920 and 922. Unlike adder circuit 910, however, multiplexor 912 selects one of the inputs rather than adding them. Multiplexor 912 selects the mantissa that corresponds to the larger floating point number. For example, when E_{fb} is greater than E_{cp}, multiplexor 912 selects M_{fb}. Also for example, when E_{cp} is greater than E_{fb}, multiplexor 912 selects M_{cp}. Multiplexor 912 drives node 913 with the selected mantissa, and node 913 is coupled to the input of register 930, which is an intermediate register similar to intermediate register 110 (FIG. 1). Shifters 902 and 904 and multiplexor 912 are in the bypass path prior to the intermediate register, and multiplexors 914 and 964 are in the bypass path subsequent to the intermediate register.

Multiplexor 914 selects the adder path when the input exponents are equal or differ by one, and selects the bypass path when the input exponents differ by more than one. When the input exponents differ by more than one, a shift of sixty-four or more would be needed to align the mantissas for addition, and the mantissas in the embodiment of FIG. 9 are fifty-seven bits long. Accordingly, the adder can be bypassed, and multiplexor 914 selects the bypass path.

In the operation of the partial normalization path, shifter 966 shifts M_{cp} thirty-two bit positions to the right if E_{fb} is two greater than E_{cp} and shifter 968 shifts M_{fb} thirty-two bit positions to the left. The results from shifters 966 and 968 are summed by adder 970, and the sum is stored in register 972, which is an intermediate register similar to intermediate register 110 (FIG. 1). Shifters 966 and 968 and adder circuit 970 are in the partial normalization path prior to the intermediate register, and shifter 976 and multiplexor 964 is in the partial normalization path subsequent to the intermediate register. Overflow detector 974 detects if an overflow exists, and produces the overflow signal OVFP on node 975. The OVFP signal is sent to the exponent path, and is also sent to shifter 976 which shifts the output of register 972 thirty-two bit positions to the right if an overflow exists.

The partial normalization path provides logic that partially normalizes M_{fb} when M_{fb} includes a significant number of leading zeros. In this case, shifters 966 and 968 re-align M_{cp} and M_{fb} prior to summation by adder 970. The partial normalization path is chosen by multiplexor 964 when E_{fb} is one or two greater than E_{cp} and more than thirty-one leading zeros exist in M_{fb}. The existence of leading zeros is detected by leading zero anticipator (LZA) 978 and comparator 980. If more than thirty-one leading zeros exist in M_{fb}, or if more than thirty-one leading ones exist in M_{fb} if M_{fb} is negative, then signal LZAgt31 on node 981 will be asserted. For a discussion of leading zero anticipators, see Kyung T. Lee and Kevin J. Nowka, “1 GHz Leading Zero Anticipator Using Independent Sign-Bit Determination Logic,” 2000 IEEE Symposium on VLSI Circuits Digest of Technical Papers, pgs 194-195.

The output of mantissa path 324 is a fifty-seven bit number in carry-save format, Mₛᵤₘ. Mₛᵤₘ is chosen from paths M, N, and P, based on logic shown in FIG. 9. The logic used to choose Mₛᵤₘ from the different paths is summarized in Table 2.

TABLE 2

| | | | |
|---|---|---|---|
| Logic | (E_{fb} = E_{cp} OR | (E_{fb} > E_{cp} + 2 OR | (E_{fb} = E_{cp} + 1 OR |
| | E_{fb} = E_{cp} + 1 OR | E_{cp} > E_{fb} + 2) | E_{fb} = E_{cp} + 2) |
| | E_{cp} = E_{fb} + 1) AND | AND | AND |
| | LZAgt31 = 0 | LZAgt31 = 0 | LZAgt31 = 1 |
| Path | Adder Path | Bypass Path | Partial |
| Providing | (Path M) | (Path N) | Normalization |
| Mₛᵤₘ | | | Path |
| | | | (Path P) |

Mantissa path 324 and exponent path 322 (FIG. 8) both include intermediate registers to provide multi-threaded capability. In the embodiments represented by FIGS. 8 and 9, two threads can be operated on simultaneously. In other embodiments, more intermediate registers are included, and more than two threads can be operated on simultaneously.

### Post-Normalization

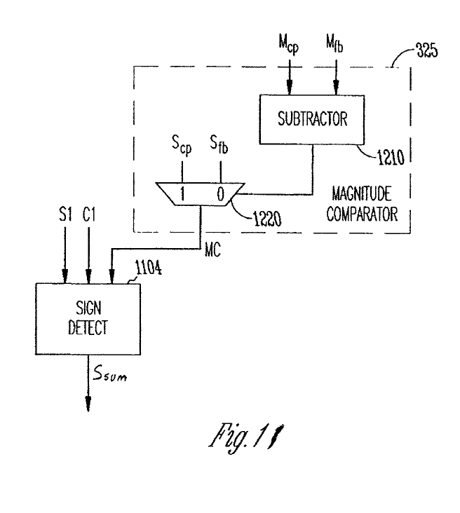

FIG. 10 shows a post-normalization circuit. Post-normalization circuit 370 includes sign detection circuit 1104, negation circuit 1102, multiplexor 1106, leading zero anticipator (LZA) 1110, carry propagate adder (CPA) 1108, shifters 1120 and 1150, and subtractors 1130 and 1140. Post-normalization circuit 370 receives the mantissa of the sum, Mₛᵤₘ, and the exponent of the sum, Eₛᵤₘ, generates the sign of the result, Sᵣₑₛᵤₗₜ, and converts the carry-save number into IEEE standard single precision format.

Mₛᵤₘ is received by sign detection circuit 1104, negation circuit 1102, and multiplexor 1106. Sign detection circuit 1104 receives Mₛᵤₘ and the magnitude compare (MC) signal produced by magnitude comparator 325 (FIG. 3), and produces Sₛᵤₘ, the sign of the sum. Sₛᵤₘ is fedback to magnitude comparator 325 as S_{fb}. The operation of sign detection circuit 1104 and magnitude comparator 325 is described in more detail below with reference to FIG. 11. Multiplexor 1106 selects between Mₛᵤₘ and a negated version thereof based on the sign of the sum, Sₛᵤₘ. This assures that the resulting mantissa is unsigned. Negation circuit 1102 can be a negation circuit such as that shown in FIG. 7.

CPA 1108 receives the mantissa in carry-save format and converts it to a binary number. Carry propagate adders are well known in the art. For an example of a carry propagate adder, see the Goto reference cited above with reference to FIG. 4. Leading zero anticipator (LZA) 1110 detects the number of leading zeros in the mantissa, and provides that information to subtractor 1130 and shifter 1120. Subtractor 1130 subtracts the number of leading zeros from the exponent, and shifter 1120 shifts the mantissa left to remove the leading zeros. In some embodiments, LZA 1110 is implemented similarly to LZA 978 (FIG. 9). The exponent and mantissa are then converted to IEEE single precision format by subtractor 1140 and shifter 1150.

FIG. 11 shows a sign detection circuit and a magnitude comparator. Magnitude comparator 325 is the same magnitude comparator shown in FIG. 3. It is shown in more detail in FIG. 11 to illustrate the combined operation of magnitude comparator 325 and sign detection circuit 1104. Magnitude comparator 325 includes subtractor 1210 and multiplexer 1220. Subtractor 1210 controls multiplexer 1220 such that MC is equal to the sign of the larger M_{cp} and M_{fb}. For example, when M_{cp} is larger than M_{fb}, MC is equal to S_{cp}. Likewise, when M_{fb} is larger than M_{cp}, MC is equal to S_{fb}. Sign detection circuit 1104 receives MC and also receives the most significant bits of the sum and carry of Mₛᵤₘ, labeled S1 and C1, respectively. Sign detection circuit 1104 includes logic that generates a sign bit in accordance with the following truth table, where “X” signifies either a 1 or a 0, and “-” indicates an impossible case.

| S1 | C1 | MC | Sign |
|---|---|---|---|
| 0 | 0 | X | 0 |
| 0 | 1 | X | 1 |
| 1 | 0 | 0 | 0 |
| 1 | 0 | 1 | 1 |
| 1 | 1 | X | — |

Magnitude comparator 325 operates in parallel with adder mantissa path 324, so MC is available for sign detection circuit 1104 at substantially the same time as Mₛᵤₘ. In this manner, the operation of sign detection circuit 1104 does not appreciably increase the delay within the feedback loop. Magnitude comparator also includes intermediate registers (not shown) to delay the result such that it matches the delay in the rest of the adder circuit.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A floating point accumulator circuit comprising:
an exponent path; and
a mantissa path having an output node fedback to an input node, and at least one sequential element in an internal data path.

2. The floating point accumulator circuit of claim 1 wherein the exponent path includes a comparator to compare three bit exponents of two floating point numbers, and the mantissa path includes a constant shifter in the internal data path to conditionally shift a mantissa of one of the two floating point numbers by thirty-two bits.

3. The floating point accumulator circuit of claim 2 wherein the mantissa path further includes:
an adder circuit to add mantissas of the two floating point numbers; and
a multiplexor in parallel with the adder to conditionally select one of the mantissas to be a resultant mantissa.

4. The floating point accumulator circuit of claim 1 wherein the mantissa path further includes an adder path and a bypass path, the adder path including an adder circuit, and the bypass path not including an adder circuit.

5. The floating point accumulator circuit of claim 4 wherein the mantissa path further includes a partial normalization path.

6. The floating point accumulation circuit of claim 5 wherein the adder path, bypass path, and partial normalization path each include at least one intermediate register.

7. The floating point accumulator circuit of claim 4 wherein the adder circuit is configured to sum numbers in carry-save format.

8. An integrated circuit comprising:
a multiplier coupled to receive operands and to produce a product; and
a multi-threaded accumulator coupled to the multiplier to receive the product.

9. The integrated circuit of claim 8 further comprising a control circuit to interleave input operands from different operand streams into the multiplier.

10. The integrated circuit of claim 8 wherein the multi-threaded accumulator is configured to sum floating point numbers having mantissas in carry-save format.

11. The integrated circuit of claim 10 wherein the multi-threaded accumulator includes at least one intermediate register to facilitate accumulating two interleaved product streams simultaneously.

12. The integrated circuit of claim 8 further comprising a floating point conversion unit coupled between the multiplier and the multi-threaded accumulator to convert the product from a first floating point representation to a second floating point representation.

13. The integrated circuit of claim 12 wherein the first floating point representation includes an exponent field having a least significant bit weight of one, and the second floating point representation includes an exponent field having a least significant bit weight of thirty-two.

14. The integrated circuit of claim 13 wherein the multi-threaded accumulator circuit includes at least one constant shifter to conditionally shift a mantissa thirty-two bit positions.

15. The integrated circuit of claim 8 wherein the integrated circuit is a circuit selected from the group comprising a processor, a memory, a memory controller, an application specific integrated circuit, and a communications device.

16. An accumulator circuit to accept operands from different threads interleaved in time, the accumulator having intermediate registers to simultaneously hold partial results from each of the different threads.

17. The accumulator circuit of claim 16 further comprising:
a constant shifter prior to a first intermediate register; and
a multiplexor subsequent to the first intermediate register.

18. The accumulator circuit of claim 17 further comprising:
an adder circuit prior to a second intermediate register; and
a second multiplexor subsequent to the second intermediate register.

19. The accumulator circuit of claim 16 wherein the operands are floating point numbers in IEEE single precision format.

20. The accumulator circuit of claim 16 wherein the operands are floating point numbers in a floating point format other than IEEE single precision format.

21. The accumulator circuit of claim 16 wherein the floating point numbers include exponent fields with a least significant bit weight other than one.

22. The accumulator circuit of claim 21 wherein the floating point numbers include exponent fields with a least significant bit weight equal to thirty-two.

23. A multi-threaded floating point multiply-accumulator circuit comprising:
a multiplier to produce a product; and
an accumulator coupled to receive the product from the multiplier, the accumulator including sequential elements to provide a multi-threaded capability.

24. The multi-threaded floating point multiply-accumulator circuit of claim 23 further comprising a floating point conversion unit to convert the product from a first exponent weight to a converted product with a second exponent weight.

25. The multi-threaded floating point multiply-accumulator circuit of claim 24 wherein the accumulator is configured to produce a present sum from the converted product and a previous sum having the second exponent weight.

26. The multi-threaded floating point multiply-accumulator circuit of claim 25 further comprising a post-normalization unit to convert the present sum to a floating point resultant having the first exponent weight.

27. The multi-threaded floating point multiply-accumulator circuit of claim 23 wherein the accumulator includes:
an adder path; and
an adder bypass path.

28. The multi-threaded floating point multiply-accumulator circuit of claim 27 wherein the multiplier is configured to produce a product with an exponent weight of one.

29. The multi-threaded floating point multiply-accumulator circuit of claim 28 further comprising a floating point conversion unit to convert the product from an exponent weight of one to an exponent weight of thirty-two.

30. The multi-threaded floating point multiply-accumulator circuit of claim 29 wherein the accumulator is configured to accumulate numbers in carry-save format.
